(19) United States
(12) Patent Application Publication
(10) Pub. No.: US 2021/0101031 A1
(43) Pub. Date: Apr. 8, 2021

(54) Securing Device

(71) Applicant: Bornack GmbH & Co. KG, Ilsfeld (DE)

(72) Inventors: Klaus Bornack, Mundelsheim (DE); Martin Keller, Heilbronn (DE)

(21) Appl. No.: 15/733,440

(22) PCT Filed: Jan. 31, 2019
(86) PCT No.: PCT/EP2019/052394

§ 371 Date: Jul. 30, 2020

(30) Foreign Application Priority Data
Feb. 1, 2018 (DE) 10 2018 102 325.1

(51) Int. Cl. A62B 35/00; F16D 63/00

(52) U.S. Cl. CPC A62B 35/0081; F16D 63/008

(57) ABSTRACT

A securing device configured for moving along with a person to be secured is disclosed. A housing has a groove and two opposed sidewalls which are spaced apart such that the groove and the sidewalls partially enclose a securing means. A lever with an attachment region is provided, to which the person is attachable, wherein the lever is pivotally mounted between the sidewalls. The lever is adapted and pivotable such that, in a securing position in which the securing means is blocked within the groove against a displacement in at least one direction along the securing means, the securing means is pressable into the groove and the attachment region protrudes out of the housing for being operated, and a release position in which the securing means is displaceable within the groove, the lever is covered between the sidewalls in the housing, such that attaching the person to the attachment region is prevented.

### CROSS-REFERENCE TO RELATED APPLICATIONS

The present application is a U.S. national phase application that emerged from the International Application No. PCT/EP2019/052394 filed Jan. 31, 2019, which designated the U.S. and claims priority to German Patent Application No. 10 2018 102 325.1 filed Feb. 1, 2018, the entire contents of both of which are incorporated herein by reference in their entirety.

### TECHNICAL FIELD

Embodiments of the invention relate to a securing device which is configured for moving along with a person to be secured along an elongated securing means. Furthermore, embodiments of the present invention relate to a securing system for securing a person with two securing devices which are configured for moving along with a person to be secured along an elongated securing means.

### TECHNOLOGICAL BACKGROUND

In particular in commercially operated climbing parks, but also at other works at heights, persons have to be secured against falling when ascending to higher stations and workplaces. The ascent takes place at ladders or other climbing structures. The descent in climbing parks typically does not take place by climbing paths with a safeguard, but via abseiling stations or zip lines which extend obliquely. In the climbing parks, there is a very high using intensity. Therefore, there are high requirements with respect to the technical conception of the securing device with respect to functional ability, safety and durability.

The user moves in the climbing facility secured with a personal protection equipment against falling. In particular, he is wearing a securing belt (safety harness or climbing harness) which is attachable to a securing means (securing rope). In order to change between multiple securing ropes, the user may be equipped with a climbing path-set with two connecting means which are V-shaped. These connecting means each possess a carabiner which ensures, for example by a communicating system, that respectively one carabiner can be opened. Thereby, completely unlatching and thus falling of the user is prevented. The securing devices which are attaching the climbing path-set to a securing rope must not hinder the user during an ascent or descent, but at the same time have to avoid situations in which the user is present in an unsecured situation by inappropriate behavior.

### SUMMARY

There may be a need to provide a securing device which does not hinder the user, but at the same time prevents situations in which the user is in an unsecured situation by inappropriate behavior.

A securing device, a securing system and a method of securing a person with a securing device are provided.

According to a first aspect of the present invention, a securing device (climbing aid) is provided which is attachable to a person to be secured and which is configured for moving along with a person to be secured along an elongated securing means (e.g. a rope or a securing bar). The securing device comprises a receiving housing which comprises a receiving groove and two sidewalls which are spaced apart and opposing each other, which extend from the receiving groove, such that the receiving groove and the sidewalls partially surround the securing means. Furthermore, the securing device comprises a securing lever with an attachment region (e.g. an opening for hooking in a carabiner or the like) to which the person is attachable. The securing lever is movably mounted between the sidewalls (e.g. pivotably and/or translationally displaceably). In particular, the securing lever is configured and movable such that
a) in a securing position in which the securing means is blocked within the receiving groove against a displacement in at least one direction along the securing means, the safety means is pushable into the receiving groove (for example directly by means of the securing lever or indirectly by means of the securing cam described below) and the attachment region is protruding from the receiving housing for being operated, and
b) in a release position in which the securing means is displaceable within the receiving groove, the securing lever is present in the receiving housing in a covered manner between the sidewalls, such that attaching the person to the attachment region is prevented.

According to a further aspect, a method of operating the above-mentioned securing device is described.

### Overview of Embodiments

As securing means, in the context of the present application, a rope, a ribbon or a grip bar and securing bar, respectively, may be described. At the securing means, the person to be secured is attached by the securing device, wherein by means of the securing device, the person to be secured may move along the securing means and may climb along, respectively, in particular along an ascent direction.

The receiving housing comprises a longitudinal extension along the securing means and encloses with the receiving groove and the both opposing sidewalls the inserted securing means. In other words, in the receiving groove, the securing means is insertable. From the receiving groove, the both sidewalls extend which are present spaced apart with respect to each other and in particular in parallel. The receiving housing correspondingly forms a U-shaped profile in cross-section.

Between the both opposing sidewalls, an installation space is provided in which the securing means is insertable and in which the securing lever is movably attached. For example, the securing lever may be pivotally attached by means of a fulcrum pin and fulcrum bolt, respectively, which is fixed to at least one of the sidewalls and protrudes in the installation space. Furthermore, guiding elements, such as a guiding groove or a guiding bar, may be arranged between the sidewalls along which the securing lever is translationally displaceable between the securing position and the release position. For example, between the both sidewalls, a kind of slide guide may be formed, such that a defined moving path (i.e. along a straight line and/or a curve) between the securing position and the release position are displaced.

The securing lever is configured with an attachment region to which the person may attach himself, for example by means of a securing belt. The attachment region may comprise an opening in which a carabiner of a person-securing rope is attached, for example. Alternatively, also a stop bolt can correspondingly be provided in the attachment region, to which corresponding securing apparatuses for securing the person can be suspended.

The securing lever is further configured and movably arranged, such that it can move between a securing position and a release position. In the securing position, the securing lever pushes and clamps, respectively, the securing means in the receiving groove, such that the securing device can no longer be displaced in a blocking direction (e.g. against an ascent direction) along the securing means. In a direction against the blocking direction, for example along an ascent direction along the securing means, the securing device may nevertheless be configured displaceable. For example, this may be ensured by a friction surface of the securing lever, which, in the securing position, is pushed against the securing means, wherein the friction surface comprises teeth, for example, which protrude with their tips in the direction of the blocking direction. Thus, the tips are hooking during a motion of the securing device in the ascent direction and against the blocking direction, respectively, and are wedging in the securing means during the motion of the securing device in the blocking direction and against the ascent direction, respectively. The friction surface may also be arranged at below-described securing cams, for example. Furthermore, by a targeted biasing of the securing lever and/or the securing cam described below, a braking force can be adjusted in a targeted manner which is acting upon the securing means in the securing position.

At the same time, the securing lever in the securing position is in a position in which the attachment region is accessible and is operable by the person and a securing carabiner, respectively, for example. In other words, in the securing position, the attachment region is protruding out of the installation space between the both sidewalls, such that the sidewalls do not cover the attachment region. As a result, in the securing position, where the attachment region can be reached by the user, a displacement and in the worst case a falling of the securing device along the securing means is prevented. By contrast, in the release position, the securing lever is adjusted and moved, respectively, such that its attachment region is present between the both sidewalls in the installation space, such that the sidewalls cover the attachment region. The user and the person, respectively, correspondingly cannot reach the attachment region and correspondingly cannot attach a carabiner at the attachment region, for example. At the same time, the securing lever releases the securing means and does not push the securing means against and in, respectively, the receiving groove in a blocking manner, respectively. Thus, the securing device can be freely displaced again and may be displaced to a desired position along the securing means, for example, without a person being secured at the securing device.

In this way, it is achieved that the securing device is present in the securing position, as soon as a person is coupled to the attachment region of the securing lever. A displacement of the securing device along the securing means in a defined blocking direction is thus not possible.

On the contrary, the securing device is in the release position, when no securing element of the person to be secured is coupled to the attachment region and the attachment region is correspondingly retracted in the installation space and is covered by the sidewalls. The security associated with this, that no person is coupled to the securing device, leads to the fact that the securing device in the release position is freely displaceable along the securing means in the blocking direction and in the ascent direction and thus can be displaced to desired target position along the securing means without a person being secured at it.

The receiving housing comprises the receiving groove which is configured such that the securing means can be at least partially inserted in the groove. The receiving groove in particular has a straight, non-curved course. The receiving groove extends along a direction, for example along the ascent direction. The securing means is inserted between the securing lever and the securing cam described below, respectively, and the receiving groove, for example, such that the securing device can be displaced relatively to the securing means and the securing lever and the securing cam, respectively, presses the securing means in the direction of the receiving groove with a corresponding friction surface.

The securing lever is attached to at least one of the sidewalls in a manner rotatable around a first rotation axis. The securing lever comprises a first end, for example. By displacement and rotation, respectively, of the securing lever, the first end is moved in the direction of the receiving body and the receiving groove, respectively, until a deadlock between the securing lever or the securing cam as described below and the receiving groove is established. At the same time, a region of the securing lever which is formed oppositely relatively to the first rotation axis with respect to the first end, is further distanced from the securing means and is moved out of the installation space between the both sidewalls. In this region, the attachment region is present. In this way, the securing position can be adjusted, wherein a blocking of the securing device along at least one direction along the securing means is realized and at the same time is securely operable.

This deadlock in the securing position leads to a high friction between the securing means or the securing cam and the receiving groove, such that a relative motion of the securing device along the securing means is limited at least in one direction. When the force which is acting upon the securing means is increased, the deadlock is reinforced, such that a relative motion between the securing device and the securing means is prevented in all directions.

The securing lever may be actuated by the person to be secured, for example. For securing, the person can move the securing lever from the release position to the securing position and can secure himself to the attachment region of the securing lever. During this securing, the securing device cannot be displaced in the blocking direction along the securing means. When the person wishes to release himself and is already in a secured position, the person can move the securing lever to the release position, wherein the securing device is displaceable along the securing means and, due to the presence of the attachment region in the installation space, it is ensured that no person is unintentionally secured to the securing device, since the attachment region is not accessible and no securing to it is possible.

In this way, a securing device is provided, wherein incorrect operations of the person to be secured may be avoided. The securing device provides, in particular by the pre-adjustment of a securing position and the release position, an intuitive operation possibility, wherein an inappropriate behavior of the person to be secured is hardly possible.

According to a further exemplary embodiment, the securing device comprises a securing cam which is movably, in particular pivotably or translationally movably, mounted between the sidewalls. The securing cam and the securing lever are arranged such that, in the securing position, the securing lever is decoupled from the securing cam and the securing cam is moving in the direction of the securing means and, in the release position, the securing lever is coupled with the securing cam, such that the securing lever is pushing away the securing cam from the securing means.

For example, the securing cam comprises the friction surface which, in the securing position, is pushed and pressed, respectively, against the securing means in the direction of the receiving groove, in order to block a displacing of the securing device in at least one direction along the securing means. The securing means may be biased, for example due to its center of gravity relatively to its rotation axis or by a first spring, such that, without acting upon and coupling, respectively, with the securing lever, the securing cam pivots and moves, respectively, to the securing position and pushes the securing means into the receiving groove.

The securing cam is attached to at least one of the sidewalls in a manner rotatable around a second rotation axis and is present in the installation space between the both sidewalls. The securing cam comprises the friction surface, for example. By rotating the securing cam, the friction surface is moved and pivoted, respectively, in the direction of the receiving body and the receiving groove, respectively, until a deadlock between the securing cam and the receiving groove is established.

The second rotation axis of the securing cam is formed between the first rotation axis and the receiving groove. Furthermore, the securing lever comprises a coupling surface which is configured such that, in the release position, the coupling surface is coupled with the securing cam, such that the securing cam is movable away, in particular pivotable away, from the receiving groove. In other words, the coupling surface of the securing lever, in the release position, pushes the friction surface of the securing cam away from the receiving groove.

In the securing position of the securing lever, the coupling surface is decoupled from the securing cam, such that the securing cam, due to its biasing or its gravitational force, is movable and may be pivoted, respectively, with its friction surface in the direction of the receiving groove. In other words, in the securing position, the friction surface of the securing cam is pushed in the direction of the receiving groove.

According to a further exemplary embodiment, the securing cam is configured such that a center of gravity of the securing cam is spaced apart to a (second) rotation axis of the securing cam, such that the securing cam is moved in the securing position due to its gravitational force and the securing cam pushes the securing means into the receiving groove. The center of gravity of the securing cam in particular may be selected such that it is formed between the first and the second rotation axis. In particular, the center of gravity of the securing cam may be specifically adjusted by specifically forming recesses in the material of the securing cam. Thus, the securing cam may be moved based on the gravitational force to the securing position in the direction of the receiving groove. The friction surface of the securing cam may thereby touch the securing means. Due to the friction, when moving the securing device in the blocking direction, the securing cam may be further moved in the direction of the receiving groove, such that the pressing force against the securing means is increased and the braking effect and blocking effect, respectively, is increased. In contrast to this, when displacing the securing device against the gravitational force, for example in the direction of the ascent direction, the securing cam may be moved away, such that the friction effect and blocking effect, respectively, is reduced.

According to a further exemplary embodiment, the securing cam is biased by means of the first spring in the direction of the securing position, such that the securing cam is moved in the securing position and the securing means is fixed in the receiving groove. For example, the first spring may be a tension spring or a compression spring which biases the securing cam in a desired moving direction and pivoting direction, respectively. Furthermore, for example a torsion spring and clock spring, respectively, may be utilized which biases the securing cam in a desired rotation direction.

According to a further exemplary embodiment, the securing lever is biased by means of a second spring in the direction of the release position, such that, in the release position, the securing cam is moved and pivoted, respectively, and the securing cam releases the securing means in the receiving groove. For example, this may be achieved by selecting the spring force of the second spring, without a person being secured at the attachment region, such that the securing lever is moved and pivoted, respectively, in the direction of the release position in a self-acting manner, such that the attachment region of the securing lever is arranged in the installation space between the sidewalls.

According to a further exemplary embodiment, the spring force of the second spring is adjusted with respect to the spring force of the first spring such that, without a coupling of a person to the attachment region, the securing lever is movable in the release position. The first spring and the second spring are constructed e.g. such that a spring force of the second spring of the securing lever is larger than a spring force of the first spring, such that, without coupling a person to the attachment region, the securing lever is movable and pivotable, respectively, in the release position. In particular, in this way the spring force of the second spring on the one hand can move and pivot, respectively, the securing lever in the release position and at the same time can overcome the spring force of the first spring and pivot and move, respectively, the securing cam, such that it does not press the securing means into the receiving groove anymore.

According to a further exemplary embodiment, the securing device comprises a rope brake which comprises a braking element which is biasable in the direction of the receiving groove. For example, the braking element may be a braking platelet and braking block, respectively, which presses the securing means into the receiving groove with a defined pressure. In the release position in which the securing lever or the securing cam does not exert any braking force on the securing means, by means of the rope brake, such a slight braking effect can be transferred to the securing means, that no uncontrolled accelerating of the securing device occurs, in particular along the direction of gravity. Thus, a controlled displacing of the securing device along the securing means can be provided in the release position.

According to a further exemplary embodiment, the securing lever is configured and movable (pivotably or translationally movable) such that, in a further securing position in which the securing means within the receiving groove is blocked along the securing means against a displacement in, in particular both, directions, i.e. along the ascent direction and the blocking direction, the securing lever pushes the securing means into the receiving groove and the attachment region protrudes out of the receiving housing for being operated. For example, the further securing position is an emergency position in which a displacement of the securing device is prevented in both directions along the securing means. In the further securing position, a second region of the securing lever pushes directly or indirectly via the securing cam in the direction of the receiving groove, such that the securing means is blocked in the receiving groove.

According to a further exemplary embodiment, the attachment region comprises an opening in which a securing element (for example a carabiner which is coupled to a safety harness of a person) is attachable. According to a further exemplary embodiment, the opening is formed as an elongated hole which is configured such that, in the securing position, the elongated hole is running with its longitudinal extension along and outside of an outer edge of the first sidewall and/or the second sidewall and thus protrudes out of the receiving housing for being operated. Thus, a securing element may be displaced and adjusted along the entire longitudinal extension when the securing lever is in the securing position.

According to a further exemplary embodiment, the opening is selectively closable by means of a carabiner. For example, the opening may thus comprise a pivotable locking element in the manner of a carabiner, such that a rope loop or a further carabiner may be introduced into the opening and may be attached to the securing lever, for example.

According to a further exemplary embodiment, the securing device comprises a blocking element with an activation system, wherein the blocking element is (for example pivotably) mounted between the sidewalls. The blocking element is configured, in a blocking position, for pushing the securing means into the receiving groove and, in a further release position, for displaceably mounting the securing means within the receiving groove, wherein the activation system is selectively adjusting the blocking element in the blocking position and the release position. The blocking element may be an adjustable brake shoe or a pivotable braking lever, for example. The blocking element may activate and deactivate the securing device. In an active state, the above described operation of the securing lever may result in that the securing device is displaceable in the release position. In an inactive state of the securing device, the blocking element is blocking each displacement of the securing device, independently from the securing lever being present in the securing position or the release position.

According to a further exemplary embodiment, the activation system is arranged at the securing lever, such that the activation system is only operable when the securing lever is present in the securing position. In other words, only in the securing position in which the attachment region is accessible by the user, the activation system can be operated and correspondingly adjust the securing device and an active or inactive state.

In the embodiments described above, in which the attachment region is configured as elongated hole, a carabiner of a connecting means may be attached for securing a person, for example. The connecting means (so-called SSB-securing system) for example possesses two separate carabiners which communicate with each other, such that respectively only one carabiner can be opened at the same time. Furthermore, a corresponding carabiner can be equipped with a locking system which can only be opened when the other carabiner is present in a secured position.

Referring to the above described embodiment in which the securing device comprises the activation system, it is possible that, when the securing lever is present in the securing position, a corresponding carabiner of the connecting means can be displaced along the elongated hole, such that a coupling element of the carabiner may activate or deactivate the activation system, as the coupling element may be coupled with the activation system by displacing the carabiner in the elongated hole. A corresponding displacement of the carabiner within the elongated hole is only possible when the securing lever is present in the securing position.

In a further exemplary embodiment, the activation system serves for, when a carabiner of a connecting means described above is coupled to the activation system, either the carabiner can be opened or another carabiner can be opened which communicates with the coupled carabiner.

According to a further aspect of the present invention, a securing system is described which is attachable to a person to be secured and configured for moving along an elongated securing means. The securing system comprises a first above described inventive securing device and a second securing device to which a person is fixable. Furthermore, the securing system comprises a spacer which is spacing the first securing device and the second securing device with respect to each other, in particular along the securing means. The second securing device may also be configured as an above described securing device according to the invention.

Thus, the securing device constitutes a catching device with automatic backstop which may be placed on a securing means which in particular runs vertically or inclinedly. The securing device may be connected with the guiding in a detachable or fixed manner.

The securing device possesses a securing lever which may be configured as braking lever (excenter) which can be folded out, to which the user hangs in by means of the integrated carabiner at its lifting eye at the safety harness.

During the ascension in the ascent direction, the user pulls the securing device with him freely and without actuating. In case of a falling, the securing lever pivots and moves, respectively, downwardly in the further securing position and blocks the securing device on the guiding immediately and without large catching distances. After reaching an upper exit point at the securing means, the user can release himself from the securing device.

For the purpose that the securing device is now ready for the next user at the entrance below, the securing device which is present in the release position slides downwardly by its own weight in a controlled and decelerated manner. Braking occurs via a rope brake, for example by a spring-loaded pressure piece as braking element which rubs at the securing means. The pressing force of the braking element is adjustable via adjusting screws and may be adapted to the states of the securing element (braking value).

Optionally, the securing lever is provided with a further abutment opening, for example the elongated hole inclusively the activation system. Thereby, the ascension securing device (securing device) is integrated into the uninterrupted securing SSB entirely and without any gaps. The user may release himself at the upper falling-dangerous exit point from the securing device, only when he already has fixed the free SSB-hook in the next abutment point.

An additional clamping cam (blocking element) in the securing device prevents an ascension when the securing device is not fixed to the safety harness in an appropriate manner.

It should be noted that the embodiments described herein merely constitute a limited selection of possible variants of the invention. It is thus possible to combine the features of single embodiments with each other in an appropriate manner, such that, with the here explicit embodiments, a multiplicity of different embodiments have to be considered as disclosed for a person skilled in the art.

### BRIEF DESCRIPTION OF THE DRAWINGS

In the following, for further explanation and for a better understanding of examples of the present invention, embodiments are described in more detail with reference to the accompanying figures. It is shown by:

FIG. 1 a schematic illustration of a first variant of an inventive securing device in the release position according to an exemplary embodiment of the present invention.

FIG. 2 a schematic illustration of a first variant of an inventive securing device in the securing position according to an exemplary embodiment of the present invention.

FIG. 3 a schematic illustration of a first variant of an inventive securing device in a further securing position according to an exemplary embodiment of the present invention.

FIG. 4 a perspective illustration of the first variant of an inventive securing device.

FIG. 5 a schematic illustration of a second variant of an inventive securing device in the release position according to an exemplary embodiment of the present invention.

FIG. 6 a schematic illustration of the second variant of an inventive securing device in the securing position according to an exemplary embodiment of the present invention.

FIG. 7 a schematic illustration of the second variant of an inventive securing device in a further securing position according to an exemplary embodiment of the present invention.

FIG. 8 a schematic illustration of a third variant of an inventive securing device in the release position according to an exemplary embodiment of the present invention.

FIG. 9 a schematic illustration of the third variant of an inventive securing device in the securing position according to an exemplary embodiment of the present invention.

FIG. 10 a schematic illustration of a securing system according to an exemplary embodiment of the present invention.

### DETAILED DESCRIPTION OF ILLUSTRATED EMBODIMENTS

Same or similar components in the figures are provided with the same reference signs. The representations in the figures are schematic and not drawn to scale.

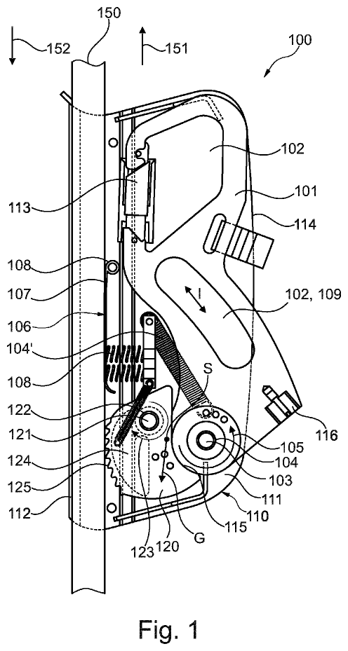

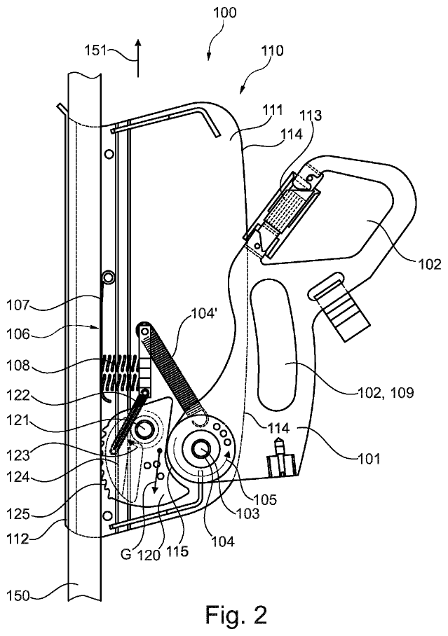

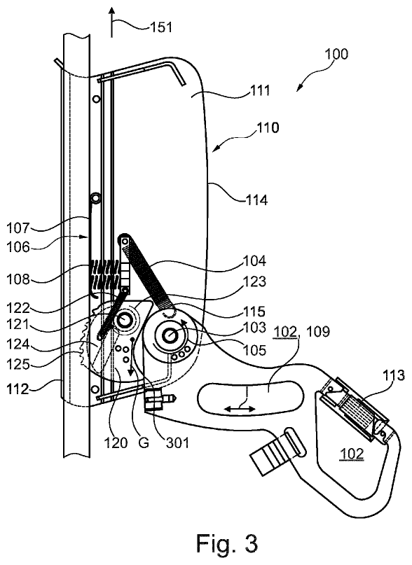

FIG. 1 to FIG. 4 show schematic representations of a first variant of an inventive securing device 100. In FIG. 1, the securing device 100 is shown in the release position, in FIG. 2, the securing device 100 is shown in the securing position, and in FIG. 3, the securing device 100 is shown in a further securing position.

The securing device 100 is attachable to a person to be secured and is configured for moving along with a person to be secured along an elongated securing means 150. A receiving housing 110 comprises a receiving groove 112 and two sidewalls which are spaced apart and opposite each other, which extend from the receiving groove 112, such that the receiving groove 112 and the sidewalls partially surround the securing means 150. A securing lever 101 with an attachment region 102 is provided to which the person is attachable, wherein the securing lever 101 is pivotably mounted between the sidewalls. The securing lever 101 is configured and pivotable such that, in a securing position in which the securing means is blocked within the receiving groove 112 against a displacement in at least one direction along the securing means 150, the securing means is pushable into the receiving groove 112 and the attachment region 102 protrudes out of the receiving housing 110 for being operated, and, in a release position in which the securing means is displaceable within the receiving groove 112, the securing lever 101 is present in the receiving housing 110 in a covered manner between the sidewalls, such that attaching the person to the attachment region 102 is prevented.

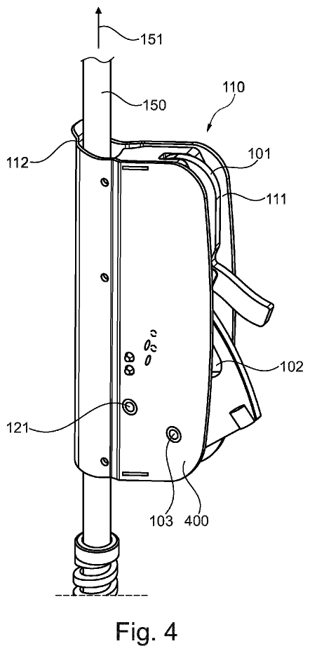

The receiving housing 110 comprises a longitudinal extension along the securing means (securing rope) 150 and encloses with the receiving groove 112 and the both opposing sidewalls the inserted securing means 150. In other words, into the receiving groove 112, the securing means 150 is insertable. From the receiving groove 112, the both sidewalls extend which are spaced apart and in particular in parallel with respect to each other. The receiving housing 110 correspondingly forms a U-shaped profile in cross-section. The receiving housing 110 is illustrated in a perspective illustration in FIG. 4.

Between the both opposing sidewalls 111, 400, an installation space is formed in which the securing means 150 is insertable and in which the securing lever 101 is pivotably mounted. For example, the securing lever 101 may be pivotably attached by means of a fulcrum pin and fulcrum bolt, respectively, which is fixed to at least one of the sidewalls 111, 400 and protrudes in the installation space.

The securing lever 101 is formed with an attachment region 102 to which the person can attach himself for example by means of a safety harness. The attachment region 102 may comprise an opening, for example, in which a carabiner of a person-securing rope is attached.

The securing lever 101 is further configured and pivotably arranged, such that it may pivot between a securing position (FIG. 2) and a release position (FIG. 1). In the securing position, the securing lever 101 and the securing cam 120, respectively, pushes and clamps, respectively, the securing means 150 in the receiving groove 112, such that the securing device 100 cannot be displaced in a blocking direction 152 along the securing means 150 anymore. In a direction opposite to the blocking direction 152, for example along an ascent direction 151 along the securing means 150, the securing device 100 may nevertheless be configured displaceable. For example, this may be provided by a friction surface 125 and braking surface, respectively, of the securing cam 120 which is pushed against the securing means 150 in the securing position. The friction surface 125 comprises teeth, for example, which protrude with their tips in the direction of the blocking direction 152. Thus, the tips do not hook during a motion of the securing device 100 in the ascent direction 151 and against the blocking direction 152, while the tips are wedging in the securing means 150 during a motion of the securing device 100 in the blocking direction 152. By a specific biasing of the securing lever 101 and/or the securing cam 120, a braking force can be adjusted in a targeted manner which acts upon the securing means 150 in the securing position.

At the same time, the securing lever 101 in the securing position is in a position in which the attachment region 102 is accessible and is operable by the person and for example a securing carabiner, respectively (see FIG. 2). In other words, in the securing position, the attachment region 102 protrudes out of the installation space between the both sidewalls 111, 400, such that the sidewalls 111, 400 do not cover the attachment region 102. This results in that, in the securing position wherein the attachment region 102 can be reached by the user, displacing and in the worst case falling of the securing device 100 along the securing means 150 is prevented.

On the contrary, in the release position, the securing lever 101 is pivoted such that its attachment region 102 is present between the both sidewalls 111, 400 in the installation space, such that the sidewalls 111, 400 cover the attachment region 102. The user and the person, respectively, correspondingly cannot reach the attachment region 102 and correspondingly cannot attach a carabiner to the attachment region 102, for example. At the same time, the securing lever 101 releases the securing means 150 and does not push the securing means 150 against the securing cam 120 in a blocking manner, respectively. Thus, the securing device 100 can be freely displaced again and can displaced for example to a desired location along the securing means 150 without a person being secured at the securing device 100.

In this way, it is achieved that the securing device 100 is present in the securing position as soon as a person is coupled to the attachment region 102 of the securing lever 101. A displacement of the securing device 100 along the securing means 150 in a defined blocking direction 152 is thus not possible.

In contrast to this, the securing device 100 is present in the release position when no securing element of the person to be secured is coupled to the attachment region 102 and the attachment region 102 is correspondingly retracted in the installation space and is covered by the sidewalls. The security associated with this, that no person is coupled to the securing device 100 results in that the securing device 100 in the release position is freely displaceable along the securing means 150 and thus can be displaced to a desired target position along the securing means 150 without a person being secured at it.

The securing lever 101 is attached to at least one of the sidewalls 111, 400 in a manner rotatable around a first rotation axis 103. For example, the securing lever 101 comprises a first end. By rotating the securing lever 101, the first end and the coupling surface 115, respectively, is pivoted in the direction of the receiving body and the receiving groove 112, respectively, until a deadlock between the securing cam 120 and the receiving groove 112 occurs. At the same time, a region of the securing lever 101 which is formed relatively to the first rotation axis 103 with respect to the first end, is further distanced to the securing means 150 and is moved out of the installation space between the both sidewalls 111, 400. In this region, the attachment region 102 is located. Thus, the securing position can be adjusted, wherein a blocking of the securing device 100 along at least one direction along the securing means 150 is realized and at the same time is safely operable.

This deadlock in the securing position leads to a high friction between the securing means 150, the securing cam 120, and the receiving groove 112, such that a relative motion of the securing device 100 along the securing means 150 is limited in at least one direction. When the force which is acting upon the securing means 150 is increased, the deadlock is reinforced, such that a relative motion between the securing device 100 and the securing means 150 is prevented in all directions. This state is described by the further securing position which is illustrated in FIG. 3.

The securing lever 101 may be actuated by the person to be secured, for example. For securing, the person may pivot the securing lever 101 from the release position to the securing position and may secure himself to the attachment region 102 of the securing lever 101. During this securing, the securing device 100 cannot be displaced in the blocking direction 152 along the securing means 150. When the person would like to release himself and is already in a secured position, the person may pivot the securing lever 101 to the release position, wherein the securing device 100 is displaceable along the securing means 150, and due to the presence of the attachment region 102 in the installation space, it is ensured that no person is unintentionally secured to the securing device 100, since the attachment region 102 is not accessible and no securing to it is possible.

The securing cam 120 and the securing lever 101 are arranged such that in the securing position, the securing lever 101 is decoupled from the securing cam 120 (FIG. 2) and the securing cam 120 moves in the direction of the securing means 150, and in the release position, the securing lever 101 is coupled with the securing cam 120, such that the securing lever 101 pushes away the securing cam 120 from the securing means 150 (FIG. 1).

The securing cam 120 comprises the friction surface 125 which, in the securing position, is pushed and pressed, respectively, against the securing means 150 in the direction of the receiving groove 112, in order to block a displacement of the securing device 100 in at least one direction along the securing means 150. The securing cam 120 may be biased, for example due to its center of gravity, relatively to its rotation axis 121 or by means of a first spring 122, such that without acting upon and coupling, respectively, with the securing lever 101, the securing cam 120 is pivoted in the securing position and pushes the securing means 150 into the receiving groove 112.

The securing cam 120 is mounted to at least one of the sidewalls 111, 400 in a manner rotatable around a second rotation axis 121 and is present in the installation space between the both sidewalls. For example, the securing cam 120 comprises the friction surface (braking surface) 125. By rotating the securing cam 120, the friction surface 125 is pivoted in the direction of the receiving body and the receiving groove 112, respectively, until a deadlock between the securing cam 120 and the receiving groove 112 is established.

The second rotation axis 121 of the securing cam 120 is formed between the first rotation axis 103 and the receiving groove 112. Furthermore, the securing lever 101 comprises a coupling surface 115 which is configured such that, in the release position, the coupling surface 115 is coupled with the securing cam 120, such that the securing cam 120 is pivotable away from the receiving groove 112. In other words, the coupling surface 115 of the securing lever 101, in the release position, pushes the friction surface 125 of the securing cam 120 away from the receiving groove 112.

In the securing position of the securing lever 101, the coupling surface 115 is decoupled from the securing cam 120, such that the securing cam 120, due to its biasing or its gravitational force G, may pivot with its friction surface 125 in the direction of the receiving groove 112. In other words, in the securing position, the friction surface 125 of the securing cam 120 is pushed in the direction of the receiving groove 112.

The securing cam 120 is formed such that a center of gravity S of the securing cam 120 is formed spaced apart with respect to a (second) rotation axis 121 of the securing cam 120, such that the securing cam 120, due to its gravitational force G, pivots in the securing position and the securing cam 120 pushes the securing means 150 into the receiving groove 112.

The center of gravity S of the securing cam 120 may in particular be selected such that it is formed between the first and the second rotation axis 121. In particular, the center of gravity S of the securing cam 120 may be specifically adjusted by specifically introducing recesses 124 in the material of the securing cam 120. Thus, the securing cam 120, based on the gravitational force, may pivot in the securing position in the direction of the receiving groove 112. The friction surface 125 of the securing cam 120 may therefore be in contact with the securing means 150. Due to the friction, during a motion of the securing device 100 in the blocking direction 152, the securing cam 120 may be pivoted further in the direction of the receiving groove 112, such that the pressing force against the securing means 150 is increased and the braking effect and blocking effect, respectively, is increased. In contrast to this, during a displacement of the securing device 100 against the gravitational force, for example in the direction of the ascent direction 151, the securing cam 120 may be pivoted away, such that the friction effect and blocking effect, respectively, is reduced.

The securing cam 120 is biased by means of a first spring 122 in the direction of the securing position, such that the securing cam 120 pivots in the securing position and fixes the securing means 150 in the receiving groove 112. The first spring 122 may be a tension spring or a compression spring, for example, which biases the securing cam 120 in a desired pivoting direction. Furthermore, a torsion spring and clock spring, respectively, may be utilized which biases the securing cam 120 in a desired rotation direction and biasing direction 123, respectively, for example.

The securing lever 101 is biased by means of a second spring 104 in the direction of the release position, such that, in the release position, the securing cam 120 pivots and the securing cam 120 releases the securing means 150 in the receiving groove 112. For example, this may be achieved by, without a person being secured at the attachment region 102, selecting the spring force of the second spring 104, such that the securing lever 101 in a self-acting manner is pivoted in the direction of the release position, such that the attachment region 102 of the securing lever 101 is located in the installation space between the sidewalls 111, 400. In the embodiment, the biasing direction 123 of the securing cam 120 acts against the biasing direction 105 of the securing lever 101.

The securing device 100 comprises a rope brake 106 which comprises a braking element 107 which is biasable in the direction of the receiving groove 112. The braking element 107 is a brake block which presses the securing means 150 into the receiving groove 112 with a defined pressure. In the release position in which the securing lever 101 or the securing cam 120 does not exert a braking force on the securing means 150, by means of the rope brake 106, such a slight braking effect can be transferred to the securing means 150, that no uncontrolled accelerating of the securing device 100, in particular along the gravitational force direction, occurs. Thus, a controlled displacing of the securing device 100 along the securing means 150 can be provided in the release position.

In FIG. 3, a further securing position is shown, in which the securing means 150 within the receiving groove 112 is blocked against a displacing in both directions 151, 152. The securing lever 101 presses the securing cam 120 against the securing means 150 in the receiving groove 112, such that securing means 150 is securely clamped. The attachment region 102 protrudes out of the receiving housing 110 for being operated. The further securing position is an emergency position, for example, in which a displacing of the securing device 100 in both directions along the securing means 150 is prevented. In the further securing position, a further region and coupling surface 301, respectively, of the securing lever 101 pushes on the securing cam 120.

For example, the attachment region 102 comprises an opening which is selectively closable by means of a carabiner 113. Furthermore, the attachment region 102 may comprise a further opening which is configured as an elongated hole 109. The elongated hole 109 is configured such that, in the securing position, the elongated hole 109 runs with its longitudinal extension I along and outside an outer edge 114 of the first sidewall 111 and/or the second sidewall 400 and thus protrudes out of the receiving housing 110 for being operated. Thus, a securing element can be displaced and adjusted along the entire longitudinal extension I, when the securing lever is located in the securing position.

Furthermore, the securing device 101 comprises an activation system 116 which is arranged at the securing lever 101, such that the activation system 116 is only operable when the securing lever 101 is present in the securing position. In other words, only in the securing position in which the attachment region 102 is accessible for the user, the activation system 116 can be operated and correspondingly adjust the securing device 100 in an active or an inactive state.

In the above described embodiment in which the attachment region 102 is configured as elongated hole 109, for example a carabiner of a connecting means can be attached for securing a person. The connecting means (so-called SSB-securing system) possesses two separate carabiners, for example, which communicate with each other, such that respectively only one carabiner can be opened at the same time. Furthermore, a corresponding carabiner may be equipped with a locking system which can only be opened when the other carabiner is present in a secured position.

Referring to the above described embodiment in which the securing device 100 comprises the activation system 116, it is possible that, when the securing lever 101 is present in the securing position, a corresponding carabiner of the connecting means may be displaced along the elongated hole 109, such that a coupling element of the carabiner may activate or deactivate the activation system 116, as the coupling element may be coupled with the activation system 116 by displacing the carabiner in the elongated hole 109. Correspondingly displacing the carabiner within the elongated hole 109 is only possible when the securing lever 101 is located in the securing position.

In a further exemplary embodiment, the activation system 116 serves for, when a carabiner of an above described connecting means is coupled to the activation system 116, either the carabiner may be opened or another carabiner which communicates with the coupled carabiner may be opened.

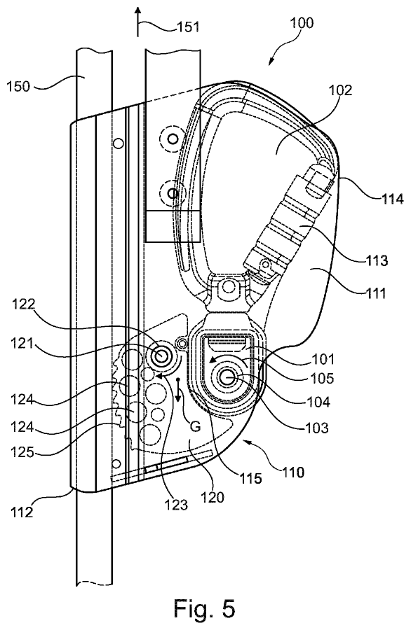

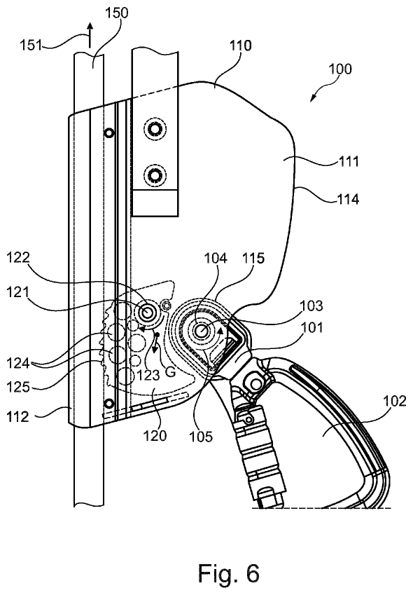

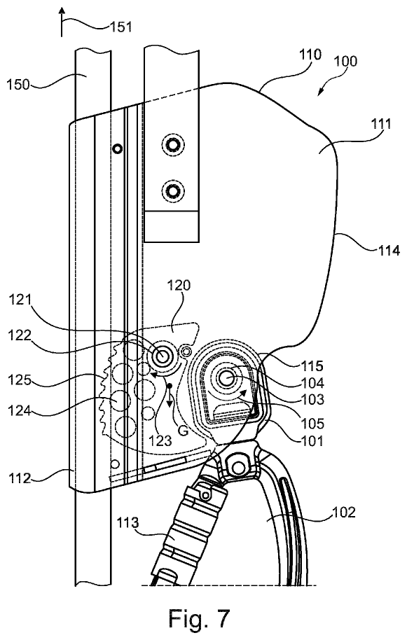

FIG. 5 to FIG. 7 show schematic illustrations of a second variant of an inventive securing device 100. In FIG. 5, the securing device 100 is shown in the release position, in FIG. 6, the securing device 100 is shown in the securing position, and in FIG. 7, the securing device 100 is shown in a further securing position.

In contrast to the first variant of the securing device 100, the securing lever 101 is configured with a carabiner 113 in the attachment region 102. In particular, the second variant of the securing device 100 may be configured more compact than the securing device 100 of FIG. 1 to FIG. 4.

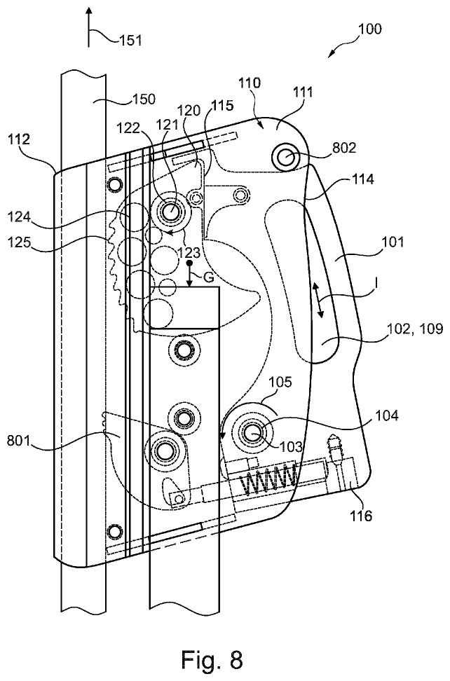

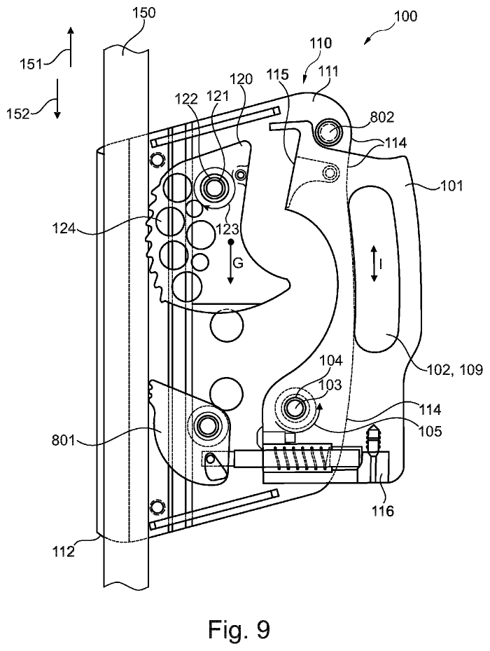

FIG. 8 and FIG. 9 show schematic illustrations of a third variant of an inventive securing device 100. In FIG. 8, the securing device 100 is shown in the release position, and in FIG. 9, the securing device 100 is shown in the securing position.

The securing lever 101 comprises an elongated hole 109 as attachment region 102. The attachment lever 101 comprises a first biasing direction 105 which is acting against the biasing direction 123 of the securing cam 120. In FIG. 8, it is illustrated that the securing lever 101 pivots with the coupling surface 115 the securing cam 120 against its biasing direction 123, such that the braking surface 125 of the securing cam does not block the securing means 150. In FIG. 9, the securing lever 101 is present in the release position, wherein the securing lever 101 is decoupled from the securing cam 120. The securing cam 120 pivots in biasing direction 123 in the direction of the securing means 150, such that a displacement of the securing device in the direction of the blocking direction 152 is blocked. A stopper 802 may prevent a further displacing of the securing lever 101.

The securing device 100 comprises a blocking element 801 with an activation system 116, wherein the blocking element 801 is pivotably mounted between the sidewalls 111, 400. The blocking element 801 is configured for pushing the securing means 150 into the receiving groove 112 in a blocking position, and for displaceably mounting the securing means 150 within the receiving groove 112 in a further release position, wherein the activation system 116 selectively adjusts the blocking element 801 in the blocking position and the release position. The blocking element is configured as pivotable braking lever. The blocking element 801 may activate and deactivate the securing device 100. In an active state, the above described operation of the securing lever 101 may result in that the securing device 100 is displaceable in the release position. In an inactive state of the securing device 100, the blocking element 801 blocks each displacement of the securing device 100 independently from the securing lever 101 being present in the securing position or the release position.

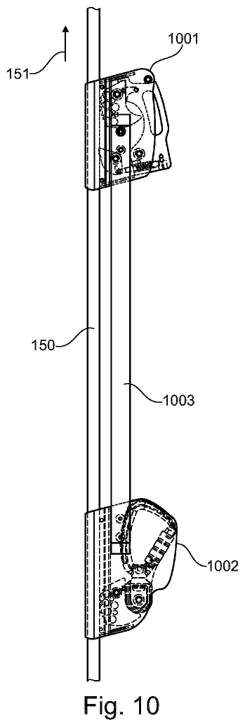

FIG. 10 shows a schematic illustration of a securing system according to an exemplary embodiment of the present invention. The securing system is attachable to a person to be secured and is configured for moving along an elongated securing means 150. The securing system comprises a first securing device 1001 and a second securing device 1002 to which a person is fixable. Furthermore, the securing system comprises a spacer 1003 which is spacing the first securing device 1001 and the second securing device 1002 with respect to each other, in particular along the securing means 150. For example, the first securing device 1001 is configured correspondingly to the embodiment of FIGS. 8 and 9, and the second securing device 1002 is configured correspondingly to the embodiment of FIG. 5 to FIG. 7, for example. Thus, the person may couple himself with multiple securing components to the securing devices 1001, 1002. In particular, the person may attach himself with an abdominal belt, for example to the second securing device 1002. For example, the person may hook in the first securing device 1001 which is spaced above in the ascent direction 151, for example by a carabiner of a connecting means (so-called SSB-securing system). A hooking-in of the carabiner of the connecting means results in that a communicating further carabiner of the connecting means can be opened, for example.

Exemplary embodiments which are described with reference to one of the above described three variants of the securing device 100 may also be applied to and integrated in the other variants of the securing device 100.

Supplementarily it should be noted that “comprising” does not exclude other elements or steps and the article “a” or “an” does not exclude a multiplicity. Furthermore, it should be noted that features or steps which are described with reference to one of the above embodiments may also be used in combination with other features or steps of other above described embodiments.

### LIST OF REFERENCE SIGNS

| | | | |
|---|---|---|---|
| 100 | securing device | 1001 | first securing device |
| 101 | securing lever | 1002 | second securing device |
| 102 | attachment region | 1003 | spacer |
| 103 | first rotation axis | | |
| 104 | second spring, rotational spring | l | longitudinal extension |
| 105 | biasing direction | | of the elongated hole |
| 106 | rope brake | G | gravitational force |
| 107 | braking element | S | center of gravity |
| 108 | third spring | | |
| 109 | elongated hole | | |
| 110 | receiving housing | 400 | second sidewall |
| 111 | sidewall | | |
| 112 | receiving groove | 801 | blocking element |
| 113 | carabiner | 802 | stopper |
| 114 | outer edge of a sidewall | | |
| 115 | coupling surface | | |
| 116 | activation system | | |
| 120 | securing cam | | |
| 121 | second rotation axis | | |
| 122 | first spring, rotational spring | | |
| 123 | biasing direction | | |
| 124 | recess | | |
| 125 | braking surface of the securing cam | | |
| 150 | securing means | | |
| 151 | ascent direction | | |
| 152 | blocking direction | | |
| 301 | further coupling surface | | |

1. The securing device which is attachable to a person to be secured and is configured for moving along with a person to be secured along an elongated securing means, the securing device comprising:
a receiving housing which comprises a receiving groove and two sidewalls which are spaced apart and opposing each other, which extend from the receiving groove, such that the receiving groove and the sidewalls partially surround the securing means,
a securing lever with an attachment region to which the person is attachable,
wherein the securing lever is movably mounted between the sidewalls,
wherein the securing lever is configured and movable such that
in a securing position in which the securing means is blocked within the receiving groove against a displacement in at least one direction along the securing means, the securing means is pushable into the receiving groove and the attachment region protrudes out of the receiving housing for being operated, and
in a release position in which the securing means is displaceable within the receiving groove, the securing lever is present in the receiving housing in a covered manner between the sidewalls, such that attaching the person at the attachment region is prevented.

2. The securing device according to claim 1, further comprising:
a securing cam which is movably, in particular pivotably, mounted between the sidewalls, wherein the securing cam and the securing lever are arranged such that, in the securing position, the securing lever is decoupled from the securing cam and the securing cam is moving in the direction of the securing means, and such that, in the release position, the securing lever is coupled with the securing cam, such that the securing lever is pushing the securing cam away from the securing means.

3. The securing device according to claim 2,
wherein the securing cam is configured such that a center of gravity of the securing cam is spaced apart to a rotation axis of the securing cam, such that the securing cam is moving in the securing position due to its gravitational force and the securing cam is pushing the securing means into the receiving groove.

4. The securing device according to claim 2,
wherein the securing cam is biased by means of a first spring in the direction of the securing position, such that the securing cam is moving in the securing position and fixes the securing means in the receiving groove.

5. The securing device according to claim 1,
wherein the securing lever is biased by means of a second spring in the direction of the release position, such that the securing cam is moving in the release position and the securing cam releases the securing means in the receiving groove.

6. The securing device according to claim 4,
wherein the spring force of the second spring is adjusted with respect to the spring force of the first spring such that, without a coupling of a person to the attachment region, the securing lever is movable in the release position.

7. The securing device according to claim 1, further comprising:
a rope brake which comprises a braking element which is biasable in the direction of the receiving groove.

8. The securing device according to claim 1,
wherein the securing lever is configured and movable such that, in a further securing position in which the securing means within the receiving groove is blocked against a displacement in both directions along the securing means, the securing lever pushes the securing means in the receiving groove and the attachment region protrudes out of the receiving housing for being operated.

9. The securing device according to claim 1,
wherein the attachment region comprises an opening in which a securing element for securing the person is attachable.

10. The securing device according to claim 9,
wherein the opening forms an elongated hole which is configured such that, in the securing position, the elongated hole is extending with its longitudinal extension (1) along and outside of an outer edge of the first sidewall and/or the second sidewall and thus protrudes out of the receiving housing for being operated.

11. The securing device according to claim 9,
wherein the opening is selectively closable by means of a carabiner.

12. The securing device according to claim 1, further comprising:
a blocking element with an activation system, wherein the blocking element is mounted between the sidewalls,
wherein the blocking element is configured, in a blocking position, for pushing the securing means into the receiving groove and, in a further release position, for displaceably mounting the securing means within the receiving groove,
wherein the activation system is selectively adjusting the blocking element in the blocking position and the release position.

13. The securing device according to claim 12, wherein the activation system is arranged at the securing lever, such that the activation system is only operable when the securing lever is present in the securing position.

14. A securing system which is attachable to a person to be secured and configured for moving along an elongated securing means, the securing system comprising:
a first securing device with a housing arranged to receive a securing means between opposed walls, the housing rotatably supporting a cam and a lever with an attachment region, the walls of the housing arranged to receive and render the attachment region of the lever inaccessible when the lever is rotated into a release position in which the cam is not in contact with the securing means, and wherein the walls are arranged to render the attachment region of the lever accessible when the lever is rotated into a securing position in which the cam is directed by the lever to contact the securing means in a manner that prevents displacement of the securing means through the housing in a first direction while permitting displacement of the securing means through the housing in the second direction;
a second securing device to which a person is fixable,
a spacer which is spacing the first securing device and the second securing device with respect to each other.

15. A method for operating a securing device, comprising:
providing a securing device with a housing, a lever and a cam separately and rotatably supported by the housing, the housing arranged with a groove for receiving a securing means, the lever arranged with an attachment region;
rotating the lever into a release position in which the attachment region of the lever is within the housing and wherein the cam does not contact the securing means such that displacement of the securing means through the housing in a first direction and in a second direction opposed to the first direction is possible; and
rotating the lever into a first securing position in which the attachment region of the lever is outside of the housing and wherein the cam contacts the securing means in a manner that prevents displacement of the securing means through the housing in a first direction while permitting displacement of the securing means through the housing in the second direction.

16. The method of claim 15, further comprising:
rotating the lever into a second securing position in which the cam contacts the securing means in a manner that prevents displacement of the securing means through the housing in the first direction and the second direction.
